(19) United States
(12) Patent Application Publication
(10) Pub. No.: US 2025/0085920 A1
(43) Pub. Date: Mar. 13, 2025

(54) CONTROL AND USER INTERFACE FEATURES OF MULTI-ZONE AUDIO AMPLIFIERS

(71) Applicant: JUKE AUDIO INC., Manhattan Beach, CA (US)

(72) Inventors: John Bradford Forth, Rio Grande, PR (US); Yutong GU, Los Angeles, CA (US); Bradford Colton Forth, Manhattan Beach, CA (US); Jerry Woods, PITTSBURGH, PA (US)

(21) Appl. No.: 18/829,160

(22) Filed: Sep. 9, 2024

Related U.S. Application Data
(60) Provisional application No. 63/537,159, filed on Sep. 7, 2023.

(51) Int. Cl. G06F 3/16; H03F 3/183; H04R 3/12; H04R 27/00; H04W 12/08

(52) U.S. Cl. CPC G06F 3/165; H04R 3/12; H04R 27/00; H04W 12/08; H03F 3/183; H03F 2200/03; H04R 2227/003; H04R 2227/005; H04R 2420/01; H04R 2420/03; H04R 2420/07

(57) ABSTRACT

A system may include an embedded computing device and amplifiers coupled to the embedded computing device. The embedded computing device may cause a user interface to be displayed on a mobile device via a mobile application. The user interface may show a list of zones and a list of audio inputs. The embedded computing device may obtain a user input via the user interface. The user input may indicate relationships between the audio inputs and the zones. The zones may represent physical locations. Each of the physical locations may include an audio output device configured to play sound. The embedded computing device may map the relationships between the audio inputs and the zones based on the user input. The amplifiers may obtain a portion of the audio inputs based on the relationships. The amplifiers may also provide the portion of the audio inputs to the audio output device.

### CROSS-REFERENCE TO RELATED APPLICATIONS

This patent application claims priority to U.S. Provisional Application No. 63/537,159 filed Sep. 7, 2023, which is incorporated herein by reference in its entirety.

### FIELD

The embodiments discussed in the present disclosure are related to multi-zone audio amplifiers.

### BACKGROUND

A building or home may include multiple zones or rooms that include separate audio output devices such as speakers. An audio system may be used to output different audio inputs at the different audio output devices. The audio system may include devices that receive the audio inputs and provide amplification to drive the audio output devices. As a number of the zones increase, multiple amplifiers or devices that provide amplification may be used to provide amplification to the audio output devices.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a system may include an embedded computing device and amplifiers coupled to the embedded computing device. The embedded computing device may cause a user interface to be displayed on a mobile device via a mobile application. The user interface may show a list of zones and a list of audio inputs. The embedded computing device may obtain a user input via the user interface. The user input may indicate relationships between the audio inputs and the zones. The zones may represent physical locations. Each of the physical locations may include an audio output device (e.g., a speaker) configured to play sound. The embedded computing device may map the relationships between the audio inputs and the zones based on the user input. The amplifiers may obtain a portion of the audio inputs based on the relationships. The amplifiers may also provide the portion of the audio inputs to the audio output device.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a block diagram of an example environment that includes a multi-zone amplifier and a mobile device to route audio inputs to multiple audio zones;

FIGS. 2-7 illustrate examples of the user interface of FIG. 1;

FIG. 8 illustrates a flow chart of an example method of connecting and controlling a multi-zone audio amplifier;

FIG. 9 illustrates a block diagram of an example computing system that may be used with the multi-zone audio amplifier;

all in accordance with one or more embodiments of the present disclosure.

### DESCRIPTION OF EMBODIMENTS

A multi-zone audio system may be used to simultaneously provide various audio output to different zones (e.g., areas) of a building or home. The multi-zone audio system may permit a single instance of audio content to be provided to multiple zones and/or permit different audio outputs to be provided separately to multiple zones at a same time.

Systems exist today that provide audio outputs to numerous zones in buildings or homes. However, these systems consist of devices that receive audio input from a variety of audio sources and provide amplification of the audio outputs to drive audio output devices. For systems in which the audio output devices are wired to a central location, the systems are complex to install and require the connection and/or configuration of a variety of components. Additionally, these wired systems may consume significant amounts of power and generate a lot of heat. These systems typically use analog signal processing between the audio sources and the audio output devices to select audio sources and relative volume levels for each of the zones. Some systems use wireless speakers or distributed amplifiers, which require their own power supplies, enclosures, signal processing and network interfaces.

According to one or more embodiments of the present disclosure, a multi-zone audio amplifier may receive multiple audio inputs and route the audio inputs to multiple zones, each of the zones include an audio output device, such as a speaker. The multi-zone audio amplifier may receive and process multiple audio inputs and provide the audio inputs to an amplifier such that the audio inputs may be provided to the speakers at an amplified level. As described in detail in the present disclosure, the multi-zone audio amplifier may provide the audio inputs to multiple amplifiers using a single data bus. Such implementations allow the multi-zone audio amplifier to be cost-effective and to perform central management of the audio outputs.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

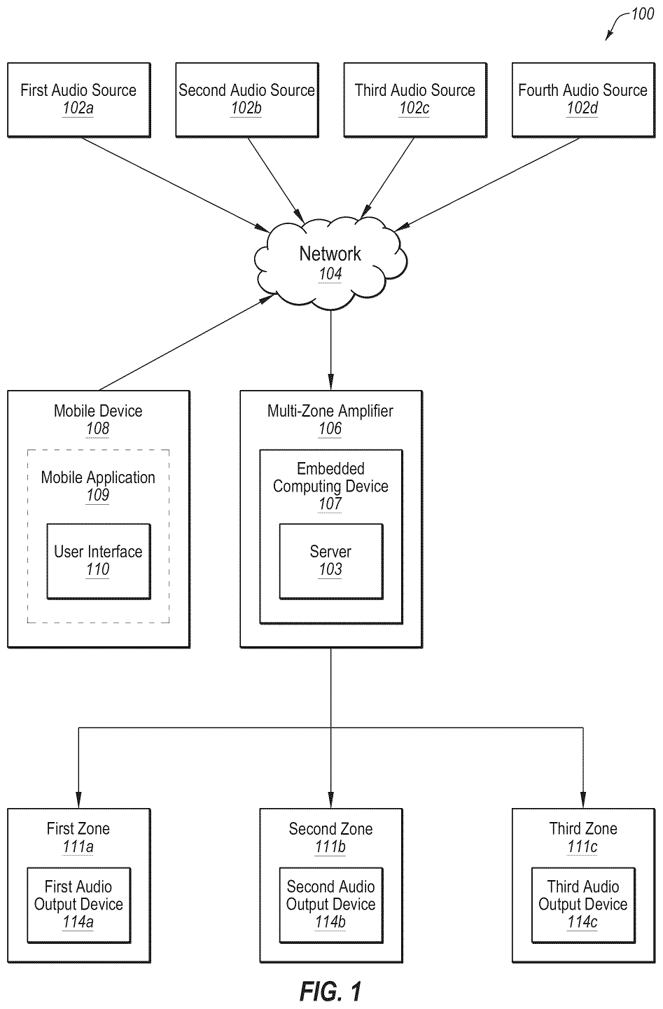

FIG. 1 illustrates an example environment 100 that includes a multi-zone amplifier 106 (“audio amplifier 106”) to route audio inputs to multiple audio zones 111a-c, in accordance with one or more embodiments of the present disclosure. The audio amplifier 106 may receive the audio inputs from multiple audio sources. For example, the audio amplifier 106 may receive the audio inputs from a first audio source 102a, a second audio source 102b, a third audio source 102c, or a fourth audio source 102d (collectively referred to as “audio sources 102”).

The audio sources 102 may include devices that are connected to the audio amplifier 106 via a network 104. For example, the audio sources 102 may include tablets, computers, smart phones, or any other appropriate wired device or wireless device. Although four audio sources 102 are illustrated, any number of audio sources or devices may be used in association with the audio amplifier 106. For example, more or fewer audio sources 102 may be used in association with the audio amplifier 106.

The network 104 may include any suitable type of network such as a local area network (LAN), a wide area network (WAN), a metropolitan area network (MAN), a personal area network (PAN), a campus area network (CAN), a storage area network (SAN), a wireless local area network (WLAN), a cellular network, a satellite network, or any other network which may receive the audio inputs from the audio sources 102 and provide the audio inputs to the audio amplifier 106. In some embodiments, the network 104 may include a Bluetooth network, Wi-Fi, and Ethernet, although other less common connection methods may also be used.

In some embodiments, the audio inputs may correspond to audio data files representative of songs stored in a digital format, audio recordings created or stored by the audio sources 102, among others. Additionally or alternatively, the audio inputs may represent any audio streaming at the audio sources 102, such as YouTube videos and other multimedia contents from the Internet. The audio sources 102 may receive the audio inputs via online sources or platforms such as Apple Music, Spotify, or any other audio stream providing services or applications that may be operating on the audio sources 102. The audio sources 102 may provide the audio inputs to the audio amplifier 106 via the network 104.

The audio amplifier 106 may route the audio inputs to the different zones 111a-c. For example, the audio amplifier 106 may include an embedded computing device 107 configured to route the audio inputs to different zones 111. For example, the embedded computing device 107 may route the audio inputs to a first zone 111a, a second zone 111b, or a third zone 111c (collectively referred to as “zones 111”). Although three zones 111 are illustrated, the audio amplifier 106 may be associated with any suitable number of zones. In the present disclosure, the zones 111 may include physical locations, such as different rooms in a building or a home, different buildings, or any other appropriate physical location. Each of the zones 111 may include audio output devices 114a-c. For example, the first zone 111a may include a first audio output device 114a, the second zone 111b may include a second audio output device 114b, and the third zone 111c may include a third audio output device 114c. Examples of the audio output devices 114a-c include speakers or any appropriate device configured to play sounds based on the audio inputs. In some embodiments, each audio output device of the audio output devices 114 may include multiple audio output devices. For example, the first audio output device 114a may include a left audio output device corresponding to a left channel of the first zone 111a and a right audio output device corresponding to a right channel of the first zone 111a.

The embedded computing device 107 may include a computing device or a processor configured to process the audio inputs. For example, the embedded computing device 107 may include a microprocessor, microcontroller, a field programmable gate array (FPGA), digital signal processor (DSP), a Raspberry Pi Module, among others. In some embodiments, the embedded computing device 107 may include multiple processors linked together to facilitate distribution and processing of the audio data.

The embedded computing device 107 may route the audio inputs from the audio sources 102 to the zones 111 in various manners. For example, the embedded computing device 107 may route the audio inputs so that each of the zones 111 receives a different audio input. In another example, the embedded computing device 107 may route the audio inputs so that at least two of the zones 111 receive the same audio input.

In some embodiments, operations of the audio amplifier 106 may be controlled based on user input received via a user interface 110. Some example operations may include setting names of the zones 111, creating mapping between the audio inputs and the zones 111, or communicating Wi-Fi credentials for connecting via the network 104, among others.

In some embodiments, the user interface 110 may be implemented via a mobile application 109 running on the mobile device 108. In some embodiments, the mobile device 108 may include any suitable device such as a smartphone, a tablet, a laptop, a personal desktop, among others. The mobile application 109 may permit a user to connect the mobile device 108 to the embedded computing device 107 via the network 104 such that the mobile device may control the embedded computing device 107 and/or operations of the audio amplifier 106.

In some embodiments, the mobile device 108 may be connected to the embedded computing device 107 via a wireless network. The mobile device 108 may cause the embedded computing device 107 to connect to the network 104 by providing network credentials (e.g., Wi-Fi credentials) to the embedded computing device 107. In these and other embodiments, the mobile device 108 and the embedded computing device 107 may establish an initial connection. The mobile device 108 may provide information regarding the connection and the network 104 to the embedded computing device 107 via the initial connection. In some embodiments, the embedded computing device 107 may provide various approaches of establishing the initial connection with the mobile device 108.

The embedded computing device 107 may operate act as a Wi-Fi access point for the mobile device 108. In some embodiments, the mobile application 109 may detect and display, via the user interface 110, the audio amplifier 106 and/or the embedded computing device 107 available to be associated with the mobile application 109 and/or the mobile device 108. The user may provide a first user input indicating the mobile device 108 is to connect to the audio amplifier 106.

The embedded computing device 107 may instruct the mobile application 109 for a password to establish the initial connection. In response to establishing the initial connection, the mobile device 108 may send a first message to the embedded computing device 107. The first message may include an identifier of the network 104. The first message may be sent via any suitable IP-based protocols such as HTTP, TCP, or UDP.

The initial connection between the mobile device 108 and the embedded computing device 107 may be established over Bluetooth. For instance, the embedded computing device 107 may broadcast a Bluetooth endpoint signal via which the mobile device 108 may establish the initial connection. In response to establishing the initial connection via Bluetooth, the mobile device 108 may send the first message.

The mobile device 108 may provide a second message to the embedded computing device 107. The second message may include network credentials (e.g., the Wi-Fi credentials or a security key) for the network 104. The embedded computing device 107 may connect to the mobile device 108 via the network 104 using the security key or the network credentials included in the second message. The second message may be sent via any suitable IP-based protocols such as HTTP, TCP, or UDP.

In some embodiments, the initial connection may be established using both the embedded computing device 107 operating as a Wi-Fi access point connection and via a Bluetooth connection. In these and other embodiments, HTTP may be used as the communication protocol for the Wi-Fi access point connection and GATT may be used as the communication protocol for the Bluetooth connection. In some embodiments, the GATT protocol may include a set of characteristics that can be written to and read. The characteristics of the GATT protocol may permit users of the multi-zone audio amplifier system to get version of the system, get available SSIDs, specify the Wi-Fi access point to connect to, specify the security credentials for the Wi-Fi access point, initiate a connection, and/or get the current status (e.g., disconnected, connecting, connected, etc.) of the Wi-Fi connection. In some embodiments, the embedded computing device 107 may indicate that the mobile device 108 may initially connect via either approach and the mobile device 108 may select one of the approaches. The mobile device 108 may select the approach based on one or more of the following factors: a signal strength, a type of the mobile device 108, the environment 100, or any other appropriate factor).

In some embodiments, the communication between the mobile device 108 and the embedded computing device 107 may use RESTful API requests over HTTP to a server 103 of the embedded computing device 107. In some embodiments, the server 103 may be hosted on the embedded computing device 107. In some embodiments, the server may comprise one of: a HTTP server, a HTTP Secure (HTTPS) server, a Websocket server, among others.

The mobile device 108 may connect to the server 103, in which the server 103 acts as a proxy to facilitate requests from the mobile application 109 to the audio amplifier 106. The server 103 may permit connection issues with respect to the network 104 to be overcome.

In some embodiments, the embedded computing device 107 may implement an authentication and device registration scheme to verify and/or authorize the mobile application to access to the audio amplifier 106. In some embodiments, the authentication process may include associating the user and/or the mobile device 108 with the audio amplifier 106 and storing such associations in a database or the server 103. In some embodiments, the association may be created during an initial set up process of the audio amplifier 106. In some embodiments, additional users or mobile devices may be associated with the audio amplifier 106 after the initial set up process. In some embodiments, with the mobile device 108 may scan a unique identifier (e.g., barcode, QR code, etc.) associated with the audio amplifier 106 to start the authentication and device registration process. In some embodiments, the audio amplifier 106 may be reset, in which previous associations of the audio amplifier 106 are reset.

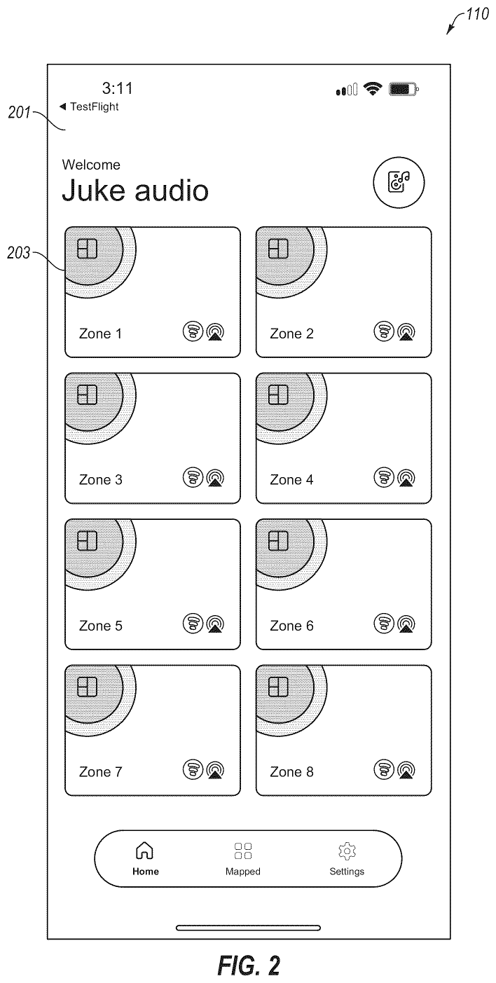

The mobile application 109 may control the operations of the audio amplifier 106, and particularly the embedded computing device 107, via the user input received via the user interface 110 displayed on the mobile device 108. For example, the embedded computing device 107 may map the audio inputs to the zones 111 based on the user input. In this example, the user input may indicate the mapping relationships between the audio inputs and the zones 111. Examples of the user interface 110 are shown in and described in more detail below in relation to FIGS. 2-7.

Modifications, additions, or omissions may be made to the environment 100 without departing from the scope of the present disclosure. For example, in some embodiments, the environment 100 may include any number of other components that may not be explicitly illustrated or described.

With reference to FIGS. 1 and 2, the user interface 110 may include a home screen 201 of the mobile application 109. The home screen 201 shows a list of graphical objects 203 representative of the zones 111. A single instance of the graphical objects 203 is numbered for ease of illustration. The user interface 110 may receive user input that is effective to select a particular graphical object of the graphical objects 203 from the list.

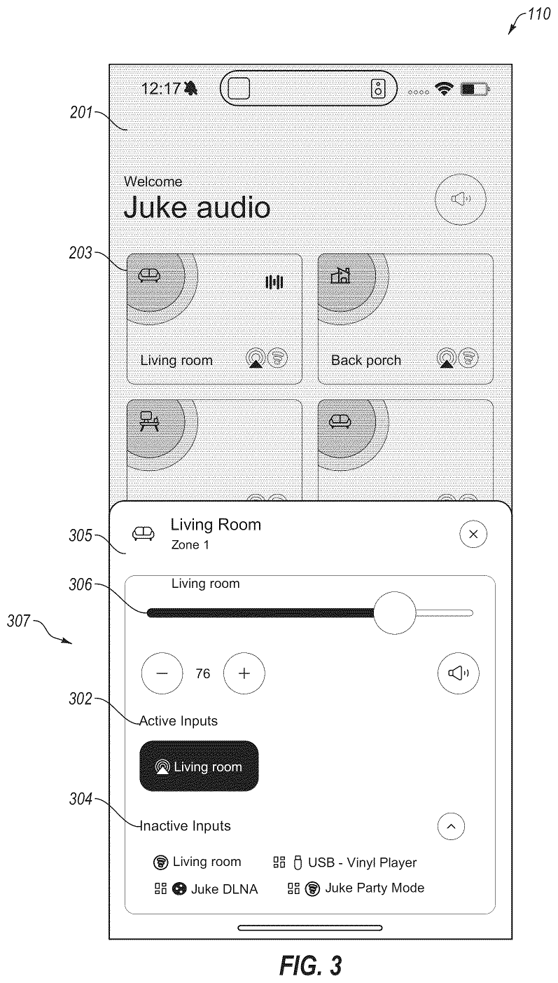

With reference to FIGS. 1 and 3, based on the user input, the user interface 110 may display a pop-up field 305. The pop-up field 305 may show information and controls for the selected zone. The information shown in the pop-up field 305 may include one or more audio inputs 307 that are mapped to the selected zone. The mapped audio inputs 307 may include active audio inputs 302 and/or inactive audio inputs 304. A single active audio input 302 is shown in FIG. 3, but multiple active audio inputs 302 may be shown. However, only a single instance of the active audio inputs 302 may be selected via the user interface 110. The user interface 110 may receive different user inputs that are effective to the select different active inputs to be played instead. In some embodiments, the pop-up field 305 may include controls 306 such as a volume control.

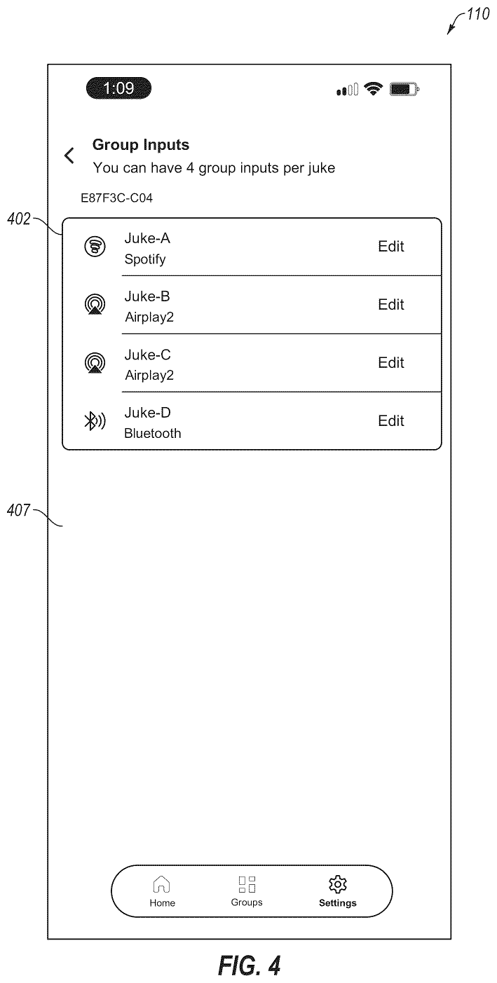

With reference to FIGS. 1 and 4, the user interface 110 may include a group input screen 407. The group input screen may illustrate group inputs 402 including two or more audio inputs that are grouped together. The group inputs 402 may be mapped as a group to one or more zones.

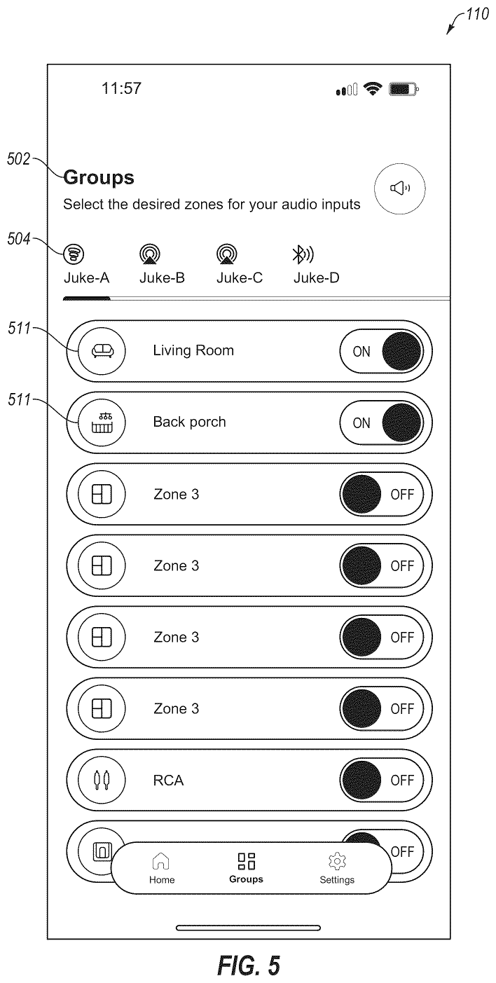

With reference to FIGS. 1 and 5, the user interface 110 may include a zone grouping screen 502. The zone grouping screen 502 may illustrate graphical object 511 representative of two or more of the zones 111 that can be grouped together. zone grouping screen 502 may permit convenient routing of audio inputs to the zones 111. The zone grouping screen 502 may show general audio inputs 504 that can be mapped to any of the zones 111 at a same time.

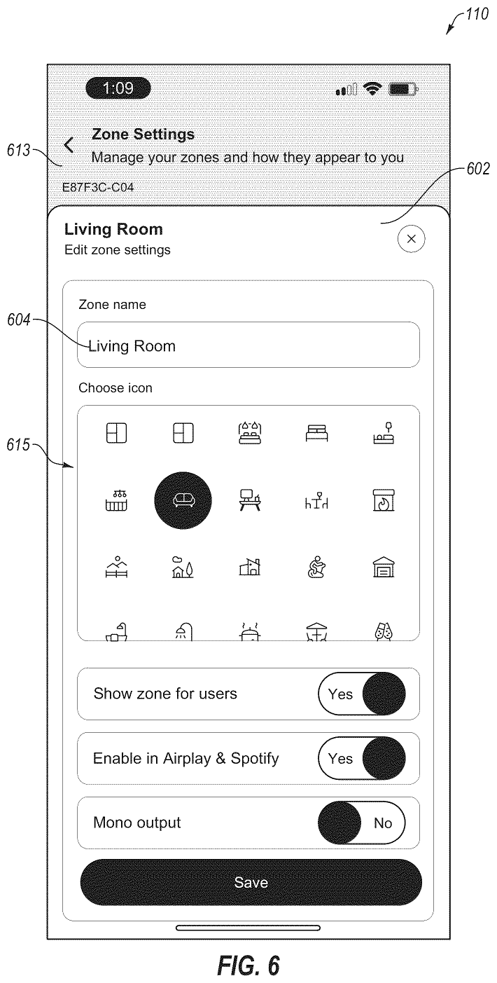

With reference to FIGS. 1 and 6, the user interface 110 may include a zone settings screen 613. The zone settings screen 613 may show a popup 602 that includes fields to setup or modify the zones 111. The popup 602 may be configured to receive user input effective to change characteristics of an zone 604. For example, the popup 602 may include a name field effective to receive user input to change the name of the zone 604. As another example, the popup 602 may include an icon field 615 effective to receive user input to change an icon representing the corresponding zone 111, among others.

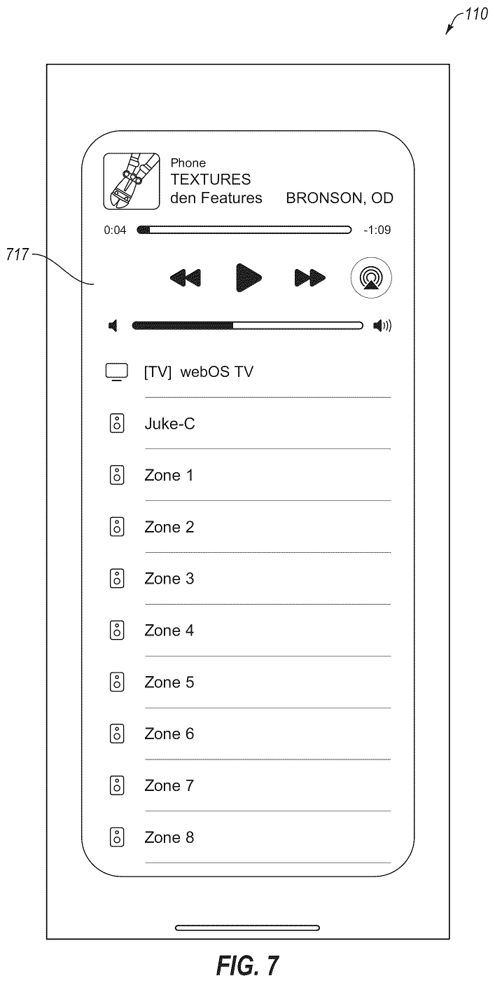

With reference to FIGS. 1 and 7, the user interface 110 may include a broadcast screen 717. The broadcast screen 717 may show the audio inputs that can be broadcast independently as a general audio input or as zone-based inputs. For example, the broadcast screen 717 shown in FIG. 7 shows a general audio input labelled “[LG] webOS TV OLED65C1AUB” and another general audio input labelled “Juke-C.” As another example, the broadcast screen 717 shown in FIG. 7 shows several zone-based audio inputs labelled as “Zone 1” to “Zone 8”.

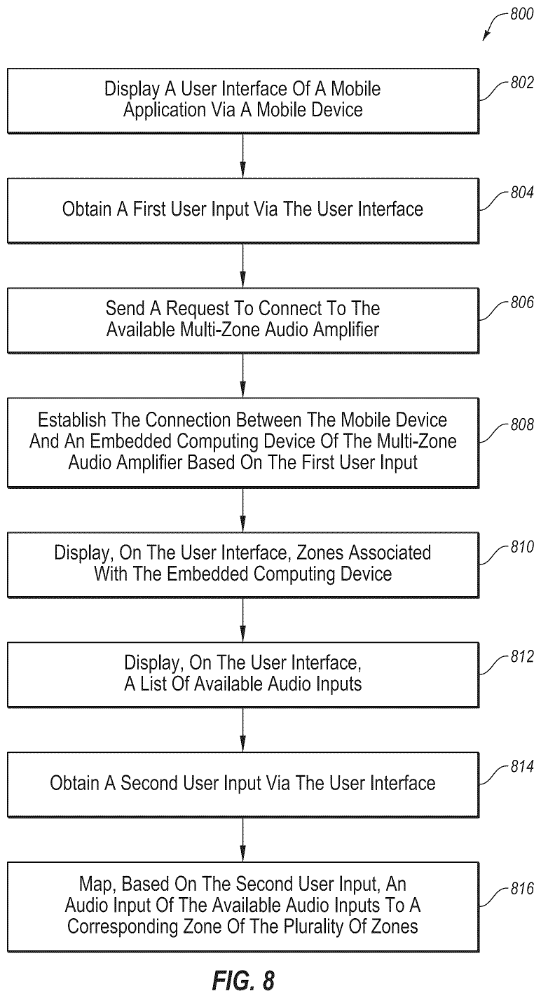

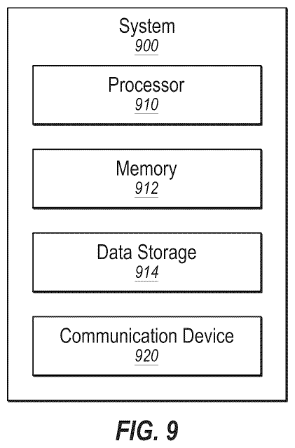

FIG. 8 illustrates a flow chart of an example method 800 of connecting and controlling a multi-zone audio amplifier, arranged in accordance with at least one embodiment of the present disclosure. One or more operations of the method 800 may be implemented by any suitable computing system such as the mobile device 108 of FIG. 1 or the computing system 900 of FIG. 9. Although illustrated as discrete steps, various steps of the method 800 may be divided into additional steps, combined into fewer steps, or eliminated, depending on the desired implementation. Additionally, the order of performance of the different steps may vary depending on the desired implementation. The method 800 may include blocks 802, 804, 806, 808, 810, 812, 814, and 816.

At block 802, a user interface of a mobile application may be displayed via a mobile device. The user interface may show an available multi-zone audio amplifier to be associated with the mobile device. In some embodiments, the multi-zone audio amplifier may be available in instances in which the mobile device identifies a signal transmitted by the multi-zone audio amplifier. For example, the multi-zone audio amplifier may be configured to broadcast a Bluetooth signal and/or be available as a Wi-Fi access point, such that the multi-zone audio amplifier may be discoverable to the mobile devices within a certain geographic region. In some embodiments, the mobile device may automatically perform discovery using multicast domain name service (MDNS) discovery. In some embodiments, the discovery may be done automatically.

At block 804, a first user input may be obtained via the user interface. The user input may indicate a connection between the mobile device and the available multi-zone audio amplifier is to be established. For example, the user input may be effective to select the discovered multi-zone audio amplifier, such that the mobile device may initiate the connection process. At block 806 a request to connect may be sent to the available multi-zone audio amplifier. In some embodiments, the request may include information about the mobile device trying to connect to the multi-zone audio amplifier.

At block 808, the connection may be established between the mobile device and an embedded computing device of the multi-zone audio amplifier based on the first user input. In some embodiments, establishing the connection may include establishing an initial connection between the mobile device and the embedded computing device with the embedded computing device acting as a Wi-Fi access point; sending, to the embedded computing device via the initial connection, a first message including an identifier of the local network for the connection; and providing, by the mobile device, a second message to the embedded computing device including the network credentials for the local network.

At block 810, zones associated with the embedded computing device may be displayed on the user interface. The zones may represent physical areas each having at least one speaker to play an output audio. In some embodiments, the embedded computing device may already be associated with a zone. In other embodiments, the embedded computing device may not yet have any associated zones. For example, the user interface may correspond to the user interface 110 of FIG. 1, in which the list of zones are displayed.

At block 812, a list of available audio inputs may be displayed on the user interface. The available audio inputs may include audio inputs generated by various audio sources. In some embodiments, an audio input may be provided using the mobile device. At block 814, a second user input may be obtained. The second user input may indicate relationships between the available audio inputs and the zones. At block 816, an audio input of the available audio inputs may be mapped to a corresponding zone of the zones based on the second user input. In these and other embodiments, the mapped audio input may be available to be played by the audio output device of the zone. For instance, the audio input may be audibly played using the speaker in the zone.

Modifications, additions, or omissions may be made to the method 800 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

FIG. 9 illustrates a block diagram of an example computing system 900 that may be used with respect a multi-zone audio amplifier, according to at least one embodiment of the present disclosure. For example, the computing system 900 may correspond to the embedded computing device 107 of FIG. 1.

The computing system 900 may include a processor 910, a memory 912, and a data storage 914. The processor 910, the memory 912, and the data storage 914 may be communicatively coupled.

In general, the processor 910 may include any suitable special-purpose or general-purpose computer, computing entity, or processing device including various computer hardware or software modules and may be configured to execute instructions stored on any applicable computer-readable storage media. For example, the processor 910 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 9, the processor 910 may include any number of processors configured to, individually or collectively, perform or direct performance of any number of operations described in the present disclosure. Additionally, one or more of the processors may be present on one or more different electronic devices, such as different servers.

In some embodiments, the processor 910 may be configured to interpret and/or execute program instructions and/or process data stored in the memory 912, the data storage 914, or the memory 912 and the data storage 914. In some embodiments, the processor 910 may fetch program instructions from the data storage 914 and load the program instructions in the memory 912. After the program instructions are loaded into memory 912, the processor 910 may execute the program instructions.

The memory 912 and the data storage 914 may include computer-readable storage media for carrying or having computer-executable instructions or data structures stored thereon. Such computer-readable storage media may include any available media that may be accessed by a general-purpose or special-purpose computer, such as the processor 910. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 910 to perform a certain operation or group of operations.

The user interface unit 920 may include any device to allow a user to interface with the computing system 900. For example, the user interface unit 920 may include a mouse, a track pad, a keyboard, buttons, camera, and/or a touchscreen, among other devices. The user interface unit 920 may receive input from a user and provide the input to the processor 910.

Modifications, additions, or omissions may be made to the computing system 900 without departing from the scope of the present disclosure. For example, in some embodiments, the computing system 900 may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A system comprising:
an embedded computing device configured to:
cause a user interface to be displayed on a mobile device via a mobile application, the user interface showing a list of a plurality of zones and a list of a plurality of audio inputs; and
obtain a user input via the user interface, the user input indicating relationships between the plurality of audio inputs and the plurality of zones, the plurality of zones representing a plurality of physical locations, each physical location having a speaker configured to play sound;
map the relationships between the plurality of audio inputs and the plurality of zones based on the user input; and
a plurality of amplifiers coupled to the embedded computing device, each amplifier of the plurality of amplifiers coupled to a different speaker, each amplifier of the plurality of amplifiers being configured to:
obtain a portion of the plurality of audio inputs based on the relationships; and
provide the portion of the plurality of audio inputs to the speaker.

2. The system of claim 1, wherein the mobile device and the embedded computing device are communicatively coupled to a server that acts as a proxy between the embedded computing device and the mobile device.

3. The system of claim 2, wherein the server comprises one of a HyperText Transfer Protocol (HTTP) server, HyperText Transfer Protocol Secure (HTTPS) server, or a Websocket server.

4. The system of claim 2, wherein the mobile device is authorized to access the server based on an association process, wherein the association process includes the mobile device recording relationship between the embedded computing device and the mobile device in a database.

5. The system of claim 1, wherein the embedded computing device is configured to be associated with a threshold number of mobile devices.

6. The system of claim 1, wherein each zone of the plurality of zones is shown in the user interface according to a location of a corresponding zone of the plurality of zones.

7. The system of claim 1, wherein the list of the plurality of zones includes a group of two or more zones.

8. The system of claim 1, wherein the embedded computing device and the mobile device are communicatively coupled to each other via a local network.

9. The system of claim 8, wherein the mobile device provides security credentials for the local network to the embedded computing device via a Bluetooth network.

10. The system of claim 8, wherein the mobile device and the embedded computing device establish an initial connection with the embedded computing device as a Wi-Fi access point, wherein the mobile device provides security credentials for the local network to the embedded computing device via the initial connection.

11. A method comprising:
displaying a user interface of a mobile application via a mobile device, the user interface showing an multi-zone audio amplifier to be associated with the mobile device;
obtaining a first user input via the user interface, indicating a connection between the mobile device and the multi-zone audio amplifier is to be established;
sending a request to connect to the multi-zone audio amplifier;
establishing the connection between the mobile device and an embedded computing device of the multi-zone audio amplifier based on the first user input;
displaying, on the user interface, a plurality of zones associated with the embedded computing device, the zones representing physical areas each having at least one speaker to play an output audio;
displaying, on the user interface, a list of available audio inputs;
obtaining a second user input, via the user interface, indicating relationships between the available audio inputs and the plurality of zones; and
mapping, based on the second user input, an audio input of the available audio inputs to a corresponding zone of the plurality of zones.

12. The method of claim 11, wherein the connection between the mobile device and the embedded computing device is established over a local network using network credentials sent from the mobile device to the embedded computing device.

13. The method of claim 12, wherein the establishing the connection between the mobile device and the multi-zone audio amplifier comprises:
establishing an initial connection between the mobile device and the embedded computing device with the embedded computing device acting as a Wi-Fi access point;
sending, to the embedded computing device via the initial connection, a first message including an identifier of the local network for the connection; and
providing, by the mobile device, a second message to the embedded computing device including the network credentials for the local network.

14. The method of claim 12, wherein the establishing the connection between the mobile device and the multi-zone audio amplifier comprises:
establishing an initial connection between the mobile device and the embedded computing device via a Bluetooth connection;
sending, to the embedded computing device via the initial connection, a first message including an identifier of the local network for the connection; and
providing, by the mobile device, a second message to the embedded computing device including the network credentials for the local network.

15. The method of claim 11, further comprising:
obtaining a third user input via the user interface to control a particular zone of the plurality of zones; and
displaying, via the user interface, a status of the particular zone, the status including one or more of: a name of the particular zone, active audio inputs associated with the particular zone, inactive audio inputs associated with the particular zone, a particular audio input from the active audio inputs being played at the particular zone, or a volume level at which the particular audio input is being played.

16. The method of claim 15, further comprising:
obtaining a fourth user input via the user interface selecting a different audio input from the active audio inputs to be played at the particular zone; and
playing the different audio input at the particular zone via a particular speaker associated with the particular zone.

17. The method of claim 11, further comprising:
obtaining a fifth user input via the user interface indicating that two zones of the plurality of zones are to be grouped;
grouping the two zones as an audio group;
displaying a status of the audio group, the status including a list of the two zones and a general audio input available to the audio group, wherein the general audio input is able to be mapped to either of the two zones of the audio group;
obtaining a sixth user input via the user interface assigning the general audio input to one or both of the two zones of the audio group; and
assigning the general audio input to the one or both of the two zones of the audio group based on the sixth user input.

18. A method comprising:
obtaining, at an embedded computing device of a multi-zone amplifier, a request to connect to the multi-zone amplifier from a mobile device, the request for a connection generated based on a first user input obtained via a user interface of a mobile application via the mobile device;
establishing the connection between the mobile device and the embedded computing device;
causing to display, on the user interface, a list of a plurality of zones associated with the embedded computing system, the zones representing physical areas each having at least one speaker to play an output audio;
causing to display, on the user interface, a list of available audio inputs, the available audio inputs representing audio data obtained from an audio source;
obtaining a second user input, via the user interface of the mobile application, indicating relationships between the available audio inputs and the plurality of zones; and
mapping, based on the second user input, an audio input of the available audio inputs to a corresponding zone of the plurality of zones.

19. The method of claim 18, further comprising:
obtaining a third user input via the user interface to control a particular zone of the plurality of zones; and
causing to display, via the user interface, a status of the particular zone, the status including one or more of: a name of the particular zone, active audio inputs associated with the particular zone, inactive audio inputs associated with the particular zone, a particular audio input from the active audio inputs being played at the particular zone, or a volume level at which the particular audio input is being played.

20. The method of claim 19, further comprising:
obtaining a fourth user input via the user interface selecting a different audio input from the active audio inputs to be played at the particular zone; and
playing the different audio input at the particular zone via a particular speaker associated with the particular zone.
